(19) United States
(12) Patent Application Publication
(10) Pub. No.: US 2008/0235758 A1
(43) Pub. Date: Sep. 25, 2008

(54) Method for processing securities data

(76) Inventor: Chuan Da Hsiung, Taipei (TW)

Correspondence Address: Raymond Sun, 12420 Woodhall Way, Tustin, CA, 92782, US

(21) Appl. No.: 12/075,518

(22) Filed: Mar. 11, 2008

(30) Foreign Application Priority Data
Mar. 21, 2007 (TW) 096109650

(51) Int. Cl. G06F 21/00

(52) U.S. Cl. 726/1

(57) ABSTRACT

A method for processing securities data comprises: analyzing a plurality of fields of a plurality of securities data in order to respectively conclude the statistic distribution summary of the values of each field of each securities data; defining a grouping and encoding process for the fields according to the distribution summary, and unifying the grouping and encoding processes for all fields into an encoding rule; and encoding the other securities data according to the encoding rule. The encoding rule can greatly reduce the amount of data and it comprises: classifying and rearranging number according to the codes of securities data in order to reduce the size of the transmission serial codes; indicating the relative price for the price of the securities data; indicating the relative time difference for the securities data which have any trading records in the previous one minute; and offering suitable field width and encoding process according to the size of each securities data to indicate its amount.

### BACKGROUND OF INVENTION

1. Field of the Invention

The invention relates to a method for processing securities data, and more particularly, to a method for encoding stock, futures, or option trading data etc. according to the data property, such that the amount of data is reduced.

2. Description of the Prior Art

Nowadays, the trading data for stock, futures, or option etc. are provided mostly from the negotiable securities authorities, stock exchange center, for example. These data can be real-time data obtained through a network leased line from the authorities, or the history data and the statistic data downloaded from the authorities at anytime. Traditionally the securities data provided by authorities are transmitted in an un-compressed standard encoding way. The data length of each field contained in each securities data should be long enough to tolerate possible maximum value. Therefore, the conventional un-compressed encoding way requires a large amount of transmission data. For those securities service providers (securities organizations, finance organizations, securities trading media organizations or securities data providers etc., for example), which acquire the securities data through a closed wire-line network, it is not a problem for such level of data amount. However, for those securities service provides which should transmit a large amount of securities data to a vast amount of customers through wireless communication, the un-compressed securities data will consume a great quantity of the precious and limited wireless communication bandwidth and result in degrading the service efficiency and quality, therefore need to be further improved.

As a typical example, a transmission format of the securities data, which is from Taiwan Securities Exchange (TSE), is shown in Chart 1. From the contents of Chart 1, the total length of the un-compressed securities data can be 97 bytes long. If thousands of securities are active in the market, the total amount of the data can be considerable.

CHART 1
An embodiment of conventional un-compressed securities data
transmission format

| Serial | Name of Field/ | | | | | |
|---|---|---|---|---|---|---|
| Number | Description | Attribute | Length | Position | Storage Mode | Remark |
| 1 | ESC-CODE | X(01) | 1 | 1-1 | ASCII 27 | |
| 2 | HEADER | | 9 | 2-10 | | |
| 2.1 | Length of | 9(04) | 2 | 2-3 | PACK BCD | |
| | Message | | | | | |
| 2.2 | Business | 9(02) | 1 | 4-4 | PACK BCD | “01” |
| | Classification | | | | | |
| 2.3 | Transmission | 9(02) | 1 | 5-5 | PACK BCD | “06” |
| | Format Code | | | | | |
| 2.4 | Transmission | 9(02) | 1 | 6-6 | PACK BCD | “01” |
| | Format Version | | | | | |
| 2.5 | Transmission | 9(08) | 4 | 7-10 | PACK BCD | |
| | Serial Number | | | | | |
| 3 | BODY | | 7-84 | | | |
| 3.1 | Stock Number | 9(04) | 2 | 11-12 | PACK BCD | |
| 3.2 | Trading Time | 9(06) | 3 | 13-15 | PACK BCD | |
| 3.3 | Revealed | X(01) | 1 | 16-16 | BIT MAP | |
| | Information | | | | | |
| | Flags | | | | | |
| 3.4 | Flags for Prices | X(01) | 1 | 17-17 | BIT MAP | |
| | Reaching Top or | | | | | |
| | Bottom, and | | | | | |
| | Suspension | | | | | |
| 3.5 | Trading Info | | 0-77 | 18-?? | | OCCURS |
| 3.5.1 | Price | 9(04)V99 | 3 | ??-?? | PACK BCD | 0-11 TIMES |
| 3.5.2 | Volume | 9(08) | 4 | ??-?? | PACK BCD | |
| 4 | Check Code | X(01) | 1 | ??-?? | XOR value | |
| 5 | TERMINAL-CODE | X(02) | 2 | ??-?? | (HEXACODE: | |
| | | | | | OD OA) | |

Wherein, the descriptions for each field in Chart 1 are as below:
1. ESC-CODE: A beginning BYTE for each RECORD, a fixed value (ASCII 27).
2. HEADER: The header field of message, each transmission format uses the same HEADER field.
2.1 Length of Message:
   (1) Represented as PACK BCD (length: 2 BYTE)
   (2) Record the length of total message (BYTE), including ESC-CODE, HEADER, BODY, Check Code and TERMINAL-CODE.
2.2 Business Classification: PACK BCD “01” represents TSE stock (length: 1 BYTE).
2.3 Transmission Format Code: PACK BCD “06” represents format 6 (length: 1 BYTE).
2.4 Transmission Format Version: PACK BCD “01” represents version 1 (length: 1 BYTE).
2.5 Transmission Serial Number:
   (1) Represented as PACK BCD (length: 4 BYTE)
   (2) Transmission serial number of this format starts from 1.
3. BODY: A variable length from 7 BYTE to 84 BYTE
3.1 Stock Number: Represented as PACK BCD

A number is used to uniquely identify a stock. The mapping between this number and corresponding stock symbol is transmitted in another format.

The Stock Number “0000” with Trading Time “999999” indicates that the last common stock real-time current prices information has been sent out.
3.2 Trading Time:

Represent the hour, minute, second of Trading Time as PACK BCD.

If the trading is suspended (judged from the Flags for Prices Reaching Top or Bottom, and Suspension bit 1-0), the Trading Time records the start and end time for the suspension.

The Stock Number “0000” with Trading Time “999999” indicates that the last common stock real-time current prices information has been sent out.
3.3 Revealed Information Flags:
   (1) Each Bit represents an item (shown as BINARY)

Bit 7 (trading price, trading volume)—0: no trading price, trading volume transmitted; 1: have trading price, trading volume.

Bit 6-4 (bid prices, bid sizes)—000: no bid prices, bid sizes transmitted; 001-101: the number (in BINARY) of bid prices, bid sizes transmitted.

Bit 3-1 (ask prices, ask sizes)—000: no ask prices, ask sizes transmitted; 001-101: the number (in BINARY) of ask prices, ask sizes transmitted.

Bit 0=0 Reserved
(2) The length of each Price field is 3 Byte; the length of each Volume field is 4 Byte.
3.4 Flags for Prices Reaching Top or Bottom, and Suspension:
   (1) Notify if prices reach Top or Bottom, and notify the instantaneous price trend of suspension (the default values are all ‘00’).

Bit 7-6, for trading price; 00: Normal 01: Price reaches Bottom 10: Price reaches Top

Bit 5-4, for bid price; 00: Normal 01: first bid price reaches bottom 10: first bid price reaches top

Bit 3-2, for ask price; 00: Normal 01: first ask price reaches bottom 10: first ask price reaches top

Bit 1-0 Suspension 00: Normal 01: suspended trading and instantaneous down trend 10: suspended trading and instantaneous up trend

Only first bid/ask price reaching top/bottom is notified.
3.5 Trading Info: The arrangements in order are trading price and volume, Best 5 bid prices and sizes, Best 5 ask prices and sizes.

The length of each “Price field” is 3 Byte; the length of each “Volume field” is 4 Byte; they are all represented as PACK BCD.

In the “Revealed Information Flags”, if the 7^{th} Bit is “1”, it represents the Trading Price and Trading Volume are existing (accumulated Trading Volume).

In the “Revealed Information Flags”, if Bit 6-4=001-101, it represents the bid prices and sizes are existing. Transmit bid prices and sizes in order started from the pair whose price is closest to the trading price.

In the “Revealed Information Flags”, if Bit 3-1=001-101, it represents the ask prices and ask sizes are existing. Transmit ask prices and sizes in order started from the pair whose price is closest to the trading price

if trading is suspended, Only the latest trading price and accumulated trading volume are transmitted, bid/ask information will not be transmitted (i.e. Revealed Information Flags 7^{th} Bit=1).
4. Check Code: Calculate the XOR value from second to the last BYTE in BODY.
5. TERMINAL-CODE: An ending BYTE for each RECORD, a fixed value(HEXACODE:0D 0A).

### SUMMARY OF INVENTION

The first objective of the invention is to disclose a method for processing the securities data, which can encode (compress) the securities data acquired from outside, so that the amount of data is reduced efficiently.

The second objective of the invention is to disclose a method for processing the securities data, which can transmit the encoded compressed securities data to user corresponding to the request while receiving a request from a user to download the securities data.

The third objective of the invention is to disclose a method for processing the securities data, which designs a distinctive data encoding method according to the property of stock, futures, or option trading data etc., such that the data amount of securities data is reduced and the transmission efficiency for user to download the securities data is raised.

In order to achieve the above objectives, the present invention discloses a method for processing the securities data comprising: analyzing a plurality of fields of a plurality of securities data in order to respectively conclude the statistic distribution summary of the values of each field of each securities data; defining a grouping and encoding process for the fields according to the distribution summary, and unifying the grouping and encoding processes for all fields into an encoding rule; and encoding the other securities data according to the encoding rule.

Wherein, the securities data comprises at least the following fields: stock code (i.e. symbol in US), transmission serial number, volume and time; moreover, the encoding rule can greatly reduce the amount of data and it comprises the followings.

Classify the securities data according to their codes, such that the securities data with the same code will be classified into the same classification and rearrange the transmission serial number by the timing sequence, and decide the length of the field for transmission series number according to the size of the transmission series number value inside the same classification, in other words, the smaller series number using the smaller (shorter) field format, the larger series number using the larger (longer) field format;

In any classification, the price of the securities data is represented as relative price; the relative price is the price difference for subtracting the price of the securities data from one reference price; the first securities data takes the Close Price in the previous day as the reference price, each of the following securities data takes the previous one prior to this securities data as reference price; moreover, decide the length of the Price field and the encoding sub-rule according to the magnitude of the value of the Price field;

In any classification, according to the degree of the time difference for each trading compared to the previous trading, the value of the time field can be decided as one of the following: time difference compared to the previous trading, or time difference relative to the Market Opening Time, or the absolute time; and decide the length of the time field according to the value of the time field after decision; and,

In any classification, decide the length of the Volume field and the encoding sub-rule according to the magnitude of the value of the Volume field of each securities data.

In order to achieve the above objectives, the method for processing securities data of the present invention further comprises the process to acquire a plurality of securities data and encode them, which comprises the following steps:

(A) Build an encoding rule. According to the distribution of the value contained in the content in each field in each of the securities, the encoding rule decides a corresponding classification and a corresponding group, and each classification and group has each corresponding default encoding sub-rule;

(B) Acquire a plurality of securities data; and,

(C) Proceed the encoding process to each securities data respectively according to the encoding sub-rule corresponding to the classification and the group.

### BRIEF DESCRIPTION OF THE DRAWINGS

FIG. 1 is a schematic view showing a system of the method for processing securities data according to a preferred embodiment of the invention;

FIG. 2 is a flow chart showing the main steps of the method for processing securities data according to an embodiment of the invention;

FIG. 3 is a flow chart showing the step of data statistic and analysis in FIG. 2 according to a detail embodiment;

FIG. 4 is a flow chart showing the step of building encoding rule in FIG. 2 according to a detail embodiment;

FIG. 5 is a flow chart showing the process to handle the download request from user in the method for processing securities data according to an embodiment of the invention;

FIG. 6 is a flow chart showing the process to encode the securities data in the method for processing securities data according to an embodiment of the invention.

### DETAILED DESCRIPTION

The main principle that underlies the method for processing securities data according to this invention is that; design a distinctive data encoding method according to the data property of stock, futures, or option trading data etc., such that the data amount of securities data is reduced and the transmission efficiency for user to download the securities data can be raised. For example, after the analysis for the stock trading information provided from the Taiwan Stock Exchange Center, we find that: 1. the turnover of around 70% stock is less than 256 orders; 2. most of the stock has trading in every minute; 3. the bid/ask prices are in a regular pattern in most (98%) stock trading information; 4. there is no much difference between two trading prices which are adjacent in time; and 5. Taiwan Stock Market has a limit of 7% on stock price fluctuation and “spread”. Therefore, the invention utilizes these properties to design a distinctive encoding rule. For example, classify the securities data according to the code of securities data and rearrange the serial number to reduce the size of the transmission serial number; represent the securities price as relative price; represent the trading time by only one bit for those securities data which have trading record in the last one minute; and offer suitable length and encoding method to represent the volume amount according to the amount of the volume for each securities data. Therefore, the total data amount for transmitting a plurality of securities data can be reduced efficiently; the transmission efficiency for user to download the securities data by wireless communication can be raised.

Thereafter the technical features and effects of the method for processing securities data of the invention will be explained by using a detail embodiment in conjunction with the accompanying drawings.

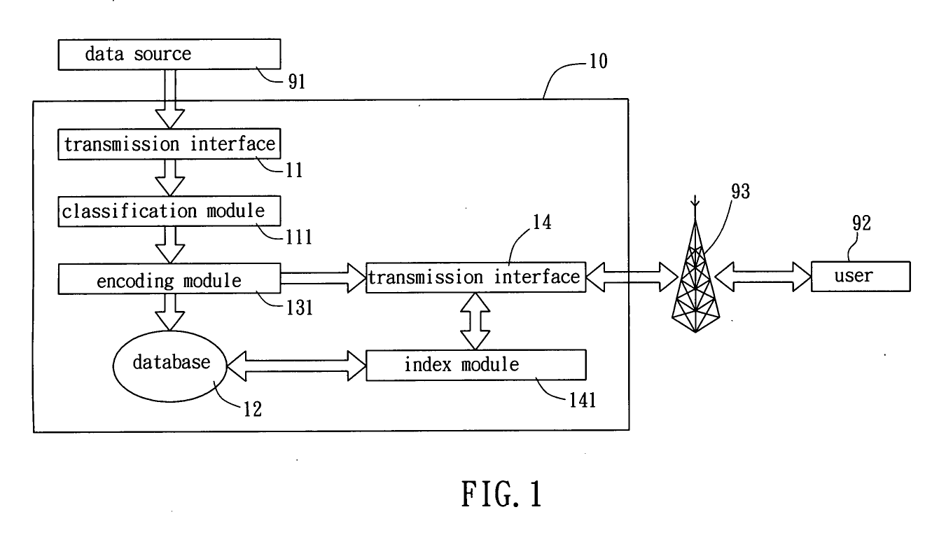

Referring to FIG. 1, which is a schematic view showing a system of the method for processing securities data according to a preferred embodiment of the invention, basically, the invention of the system for processing securities data 10 is established in a communication environment; such an environment is formed by combining a communication system (for example, wireless communication systems like GSM, CDMA, GPRS, PHS, and WLAN, but is not limited to such scope) with a closed-off network. The environment allows at least one data source 91 and at least one user 92 to proceed the communication for transmitting securities data. In this preferred embodiment, the data source 91 is a negotiable securities management authority, for example, stock exchange center etc.; and the securities data could be: stock trading data, futures trading data and option trading data etc. The user 92 can be a smart phone which can execute the wireless data transmission, a handheld stock exchange terminal, or a portable PDA with mobile communication function etc. Such devices connect to the wireless communication base station 93 set up by a mobile communication service provider via a mobile communication network like GPRS (General Packet Radio Service). Subsequently, the mobile communication service provider is allowed to connect to the system for processing the securities data of the invention 10 via the closed-off network, and this in turn enables the system for processing the securities data of the invention 10 and user 92 to connect to each other wirelessly and transmit data.

As shown in FIG. 1, the system for processing the securities data of the invention 10 comprises: a first transmission interface 11 which is used to provide the connection to the data source 91 and acquire the securities, a classification module 111 which is used to classify the securities transmitted from data source 91, a encoding module which is used to encode and compress the securities data to reduce the data amount, a database 12 which is used to store the securities data after the encoding and compressing process, and a second transmission interface 14 which is used for user 92 to connect and download the securities data from the database 12 through the wireless communication base station 93 set up by the mobile communication service provider. In this embodiment, these transmission interfaces 11, 13, database 12 and encoding module 131 are composed of a plurality of servers to supply numerous users to use the system 10 at the same time. Certainly, in another embodiment, we can choose to integrate the system for processing the securities data of the invention 10 into the same server. In this embodiment, after the classification done by the classification module 111, and the encoding and compressing process done by encoding module 131, on one hand the securities data transmitted from the data source 91 can be pushed to user 92 instantaneously and directly, on the other hand they can be stored into the database 12 then user 92 can proceed the download later on. Between the second transmission interface 14 and the database 12 there is a index module 1 which can accept a request from user 92 to download data, and get the corresponding securities data from the database 12, then transmit to user 92.

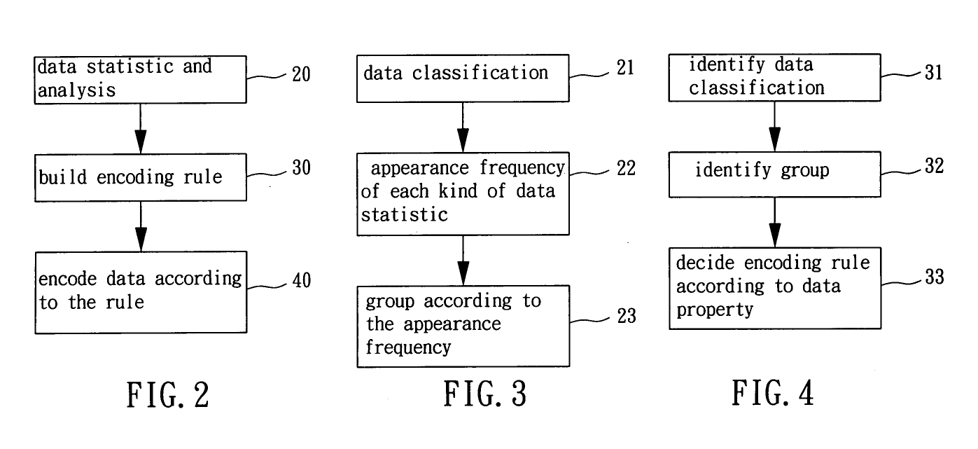

Please refer to FIG. 2, which is a flow chart showing the main steps of the method for processing securities data according to an embodiment of the invention. Basically the method for processing securities data of the invention comprises the following main steps:

Step 20: Data statistic and analysis. Respectively conclude the statistic distribution summary of the values of each field contained in each securities data according to the analysis through all the field contents of a great quantity old securities data. In brief, it is to find the data property for the values in each field of the securities data according to the statistic analysis.

Step 30: Build encoding rule. Define a grouping and encoding sub-rule for the fields according to the data property of the values in each field, for example, the occurrence frequency of the values or their distribution portion, and unify the grouping and encoding processes for all fields into an encoding rule.

Step 40: Encode data according to the rule. Proceed to encode the other following securities data according to the encoding rule to reduce the data amount.

Please refer to FIG. 3, which is a flow chart showing the step of data statistic and analysis in FIG. 2 according to a detail embodiment. The step 20 of data statistic and analysis can further comprises the following:

Step 21: Classify the data. The classification method proceeds the classification according to the code of securities data (for example, stock code etc.) such that the securities data with the same code will be classified in the same classification, and rearrange the transmission serial number.

Step 22: Counter the appearance frequency of each kind of data statistic. Take the Taiwan Stock trading for example, we can know from the statistic that the turnover of most stock are less than 256 orders; most of the stock has trading in every minute; the prices for the Bid and Ask are the same in most stock trading information; there is no much difference between two trading prices which are neighboring in time, Taiwan Stock Market has the limitation 7% for the Up and Down and the concept of “spread”.

Step 23: Divide into groups according to the appearance frequency. Decide the groups according to the appearance frequency of the values of each field, for example (but not limited to): For those values with appearance frequency higher than 75% belong to Group 1, the ones with appearance frequency between 5˜25% belong to Group 2, the ones with appearance frequency between 1˜5% belong to Group 3, the ones with appearance frequency lower than 1% or the ones reserved for the future expansion belong to Group 4.

Please refer to FIG. 4, which is a flow chart showing the step of building encoding rule in FIG. 2 according to a detail embodiment. The step 30 of building encoding rule can further comprises the following:

Step 31: Identify data classification. Classify securities data according to the codes of securities data, and proceed the statistic analysis to each classified securities data respectively.

Step 32: Identify group. Decide the groups according to the values of each field of securities data in each classification, and analyze the data property of each field in each group, for example, the Digits, extreme value and floating interval of each value in the same field in the same group.

Step 33: Decide the encoding rule according the data property. After analyzing the data property of each field in each group, we can plan an optimized encoding sub-rule and field length to represent its value. Therefore we can design a default encoding sub-rule corresponding to the group and the classification according to the data property and the distribution situation of the contents of each field of each securities data. Then, unify all encoding sub-rules corresponding to each group and each classification into an encoding rule.

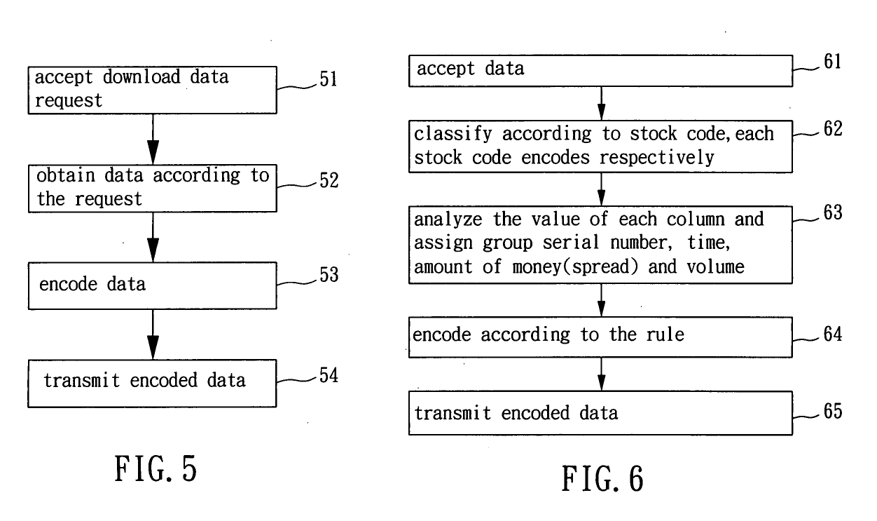

Referring to FIG. 5, which is a flow chart showing the process to handle the download request from user in the method for processing securities data according to an embodiment of the invention, comprises the following steps:

Step 51: Accept a request to download securities data from user.

Step 52: Obtain a plurality of securities data from database or outside data source according to the request.

Step 53: If the request asks for uncompressed securities data from outside data source, then proceed the encoding process to each securities data according to the encoding rule mentioned before; according to the content in each field in each of the securities, the encoding rule decides a corresponding classification and a corresponding group, and each classification and group has each corresponding default encoding sub-rule. Relatively, if the request asks for the compressed securities data from database, then jump to step 54 directly without executing the encoding process in this step.

Step 54: Transmit a plurality of securities data after the encoding.

Referring to FIG. 6, which is a flow chart showing the process to encode the securities data in the method for processing securities data according to an embodiment of the invention, comprises the following steps:

Step 61: Accept a plurality of securities data.

Step 62: Proceed the classification according to the codes (for example, stock code etc.) of securities data, such that the securities data with the same code will be classified into the same classification, and rearrange the transmission serial number, and encode the securities data belonged to each classification respectively.

Step 63: Analyze the value of each field and group it. In this embodiment, the securities data comprises at least the following fields: code, transmission serial number, price (for example, trading time, spread or amount), volume (for example, trading volume), and time (for example, trading time). In this step, according the content (for example, value) of each field of each securities data in each classification to decide the corresponding group. As what is mentioned before, each classification and group has each corresponding default encoding sub-rule.

Step 64: Proceed the encoding process to each securities data according to the encoding sub-rule corresponding to the classification and group.

Step 65: Transmit a plurality of securities data after the encoding or save them into the database.

Please refer Chart 2 to Chart 6, which indicate the transmission format of the securities data after encoding and compressing for one embodiment of the method for processing the securities data of the invention.

CHART 2
The transmission format of the securities data in the
method for processing the securities data of the invention
First Embodiment

| | | Length | | |
|---|---|---|---|---|
| Field Name | Sub Field | (Bit) | Field Content | Description |
| Time | | 2/8/14 | Time Group, | |
| | | | please see | |
| | | | Chart3 | |
| Status | | 1/2 | | 0: normal, 10: Price reaches Top, |
| | | | | 11: Price reaches Bottom |
| Trading | | | | Trading Price and Volume |
| Information | | | | |
| | SN | 9/12/14 | Serial | Start from 1 for the transmission |
| | | | Number, please | serial number in each |
| | | | see Chart 4 | classification. |
| | Price | var | Price Group, | Trading Price. SN1: relative to |
| | Format | | please see Chart | Reference Price; SNx, x > 1: |
| | | | 5 | relative to SNx-1 |
| | Volume | var | Volume Group, | Trading Volume (Single |
| | Format | | please see Chart | Amount) |
| | | | 6 | |
| Top-5 Spread | | 3 | 0~5 | Data Amount of Bid and Ask |
| for Bid and | | | | prices and Volume |
| Ask prices | | | | |
| and Volume | | | | |
| Amount | | | | |
| (ba_data_count) | | | | |
| Transmission | | | | Data of Bid and Ask prices and |
| Data Content | | | | Volume Amount; repeat |
| | | | | (ba_data_count) time |
| | Bid prices | var | Price Group, | 1. Bid/Ask prices: 1 = |
| | | | please see Chart | relative to Trading Price; |
| | | | 5 | n = relative to n-1 order |
| | Bid sizes | var | Volume Group, | Bid/Ask prices. |
| | | | please see Chart | |
| | | | 6 | |
| | Ask prices | var | Price Group, | |
| | | | please see Chart | |
| | | | 5 | |
| | Ask sizes | var | Volume Group | |
| | | | please see Chart | |
| | | | 6 | |

CHART 3
Each group value and its representative encoding format of time field

| | Group Sub | | | |
|---|---|---|---|---|
| | Field | | Range of | |
| | (binary | | Group Sub | |
| | prefix | Length | Field value | |
| Group | code) | (Bit) | Minute in Unit | Description |
| 1 | 0 | 1 | 0~1 | Relative to the previous |
| | | | | order; if the transmission |
| | | | | serial number = 1, |
| | | | | relative to the |
| | | | | Open Market Time |
| 2 | 10 | 6 | 2~65 | Relative to the previous |
| | | | | order; if the transmission |
| | | | | serial number = 1, |
| | | | | relative to the |
| | | | | Open Market Time |
| 3 | 11 | 12 | 0~1439 | Absolute time |
| | | | | 0(0:00)-1439(23:59) |

As shown in Chart 3, the time field of the securities data further comprises a group sub field and a time sub field. The group sub field represents the group value of the time sub field of the securities data as prefix code, the length is 1 or 2 bits; wherein:

when the group value of the time field is 0, the length of the time sub field is 1 bit, which is used to indicate the time difference for the securities data relative to the previous one is 0 minute or 1 minute or one of the both;

when the group value of the time field is 2 (binary: 10), the length of the time sub field is 6 bits, which is used to indicate the time difference for the securities data relative to the previous one; the unit of the value in the time sub field is minute and it is between 2 to 65; and

when the group value of the time field is 3 (binary: 11), the length of the time sub field is 12 bits, which is used to indicate the absolute time for the securities; the unit of the value in the time sub field is minute and it is between 0 (0 hour 0 minute) to 1439 (23 hour 59 minute).

According to the statistic, around 80% of the Taiwan securities trading data is belonged to group 1, which means there is trading data before/after one minute.

CHART 4
Each group and its representative encoding format
of transmission serial number field

| | Group Sub | Serial Number | |
|---|---|---|---|
| | Field Value | Sub Field | |
| | (binary prefix | Length | Range of the |
| | code) | (Bit) | Value |
| 1 | 0 | 8 | 1~256 |
| 2 | 10 | 10 | 257~1280 |
| 3 | 11 | 12 | 1281~5376 |

As shown in Chart 4, the transmission serial number of the securities data further comprises a group sub field and a serial number sub field. The group sub field represents whether the length of the group value of the serial number sub field of the securities data is 1 or 2 bits as prefix code; wherein:

when the group value of the serial number field is 0, the length of the serial number sub field is 8 bits, which indicates the transmission serial number for 1˜256 orders;

when the group value of the serial number field is 2, the length of the serial number sub field is 10 bits, which indicates the transmission serial number for 257˜1280 orders; and,

when the group value of the serial number field is 3 (binary: 11), the length of the serial number sub field is 12 bits, which indicates the transmission serial number for 1281˜5376 orders.

According to the statistic, Currently Taiwan Stock Market has 1101 Spreads (new revised Taiwan Index) at most, therefore, the group 1 and group 2 can cover all the Taiwan stocks, and group 3 is reserved for the expansion use for the possible 24 hours trading in the future.

CHART 5
Each group and its representative encoding format of Price field

| | Group | | Range of the Value | |
|---|---|---|---|---|
| | Sub Field | Length | Price/Decimal Point | |
| Field | Value | (Bit) | Sub Field | Description |
| Sub | | 3 | 0~7 | |
| Field | | | | |
| Value | | | | |
| Price | | | | |
| | Absolute | | | |
| | Price | | | |
| | Group | 5 | 0~31 | |
| | Value = 0 | | | |
| | Group | 10 | 32~1055 | 1055 = 32 + 2\hat{ }10 − 1 |
| | Value = 1 | | | |
| | Group | 15 | 1056~33823 | 33823 = 1056 + 2\hat{ }15 − 1 |
| | Value = 2 | | | |
| | Group | 20 | 33824~1082399 | 1082399 = 33824 + 2\hat{ }20 − 1 |
| | Value = 3 | | | |
| | Relative | | | |
| | Price | | | |
| | Group | 0 | — | |
| | Value = 4 | | | |
| | Group | 2 | 00: 1, 10: −1, 01: 5, | |
| | Value = 5 | | 11: −5 | |
| | Group | 3 | 000~011: +2~+4, +6; | |
| | Value = 6 | | 100~111: −2~−4, −6 | |
| | Group | 5 | 00000~01111: | |
| | Value = 7 | | +7~+22; | |
| | | | 10000~11111: −7~−22 | |
| Decimal | | 0/2 | 0~3 (imply how many | When Group Value = 4, no this |
| Point | | | decimal point) | field; 2 bits in the other condition |

As shown in Chart 5, the Price field of the securities data can further comprise a group sub field, a price sub field, and a decimal sub field; and the encoding sub-rule can further comprise: in any classification, the price sub field of the Price field for the first order securities data basically records the relative price relative to the Close Price in the previous trading day; and for the following securities data, the price sub field basically records the relative price relative to the price of the previous order securities data. If there is no way to represent as relative price, for example, the relative difference value is too large or there is no suitable reference price, then represent as absolute value; wherein, the group sub field value is used to represent the encoding sub-rule in the price sub field of the securities data. In a plurality of securities data, because most of the Price fields can be represented as relative price, therefore the necessary bits using in the price sub field are relative fewer to achieve the effect for reducing the data amount.

Wherein, the length of the group sub field of the Price field is 3 bits which is used to represent the group value from 0 to 7, and the length of the decimal sub field of the Price field is 0 or 2 bits which is used to imply how many decimal point in the price sub field; wherein:

when the group value of the Price field is 0, the length of the price sub field is 5 bits, which is used to indicate the absolute price value from 0 to 31;

when the group value of the Price field is 1, the length of the price sub field is 10 bits, which is used to indicate the absolute price value from 32 to 1055;

when the group value of the Price field is 2, the length of the price sub field is 15 bits, which is used to indicate the absolute price value from 1056 to 33823;

when the group value of the Price field is 3, the length of the price sub field is 20 bits, which is used to indicate the absolute price value from 33824 to 1082399;

when the group value of the Price field is 4, the length of the price sub field is 0 bit, which is used to indicate the relative price value is 0;

when the group value of the Price field is 5, the length of the price sub field is 2 bits, which is used to indicate the relative price value is one of the following: 1, −1, 5, −5;

when the group value of the Price field is 6, the length of the price sub field is 3 bits, which is used to indicate the relative price value is one of the following: 2˜4, 6, −2˜−4, and −6; and,

when the group value of the Price field is 7, the length of the price sub field is 5 bits, which is used to indicate the relative price value is one of the following: 7˜22 and −7˜−22.

CHART 6
Each group and its representative encoding format of Volume field

| | | | Range of Value | |
|---|---|---|---|---|
| | Group Sub | Length | Volume/Index Sub | |
| Field | Field Value | (Bit) | Field | Description |
| Sub Field | | 3 | 0~7 | |
| Value | | | | |
| Volume | | | | |
| | Group Value = 0 | 5 | 0~31 | |
| | Group Value = 1 | 10 | 32~1055 | 1055 = 32 + 2\hat{ }10 − 1 |
| | Group Value = 2 | 15 | 1056~33823 | 33823 = 1056 + 2\hat{ }15 − 1 |
| | Group Value = 3 | 20 | 33824~1082399 | 1082399 = 33824 + 2\hat{ }20 − 1 |
| | Group Value = 4 | 25 | 1082400~34636831 | 34636831 = 1082400 + 2\hat{ }25 − 1 |
| | Group Value = 5 | 10 | 0~1023 | for X.XX |
| | Group Value = 6 | 14 | 0~16383 | for XX.XX |
| | Group Value = 7 | 17 | 0~131071 | for XXX.XX |
| Index (only | | 0/2 | 0~3 | 0: K, 1: M, 2: B, 3: T |
| when Group | | | | |
| Value = 5~7) | | | | |

As shown in Chart 6, the Volume field of the securities data can further comprise a group sub field, a price sub field, and an index value; the length of the index value field is not longer than 2 bits and is used to represent that the value of the volume sub field should be multiplied by 10 to the exponent power again; the length of the group sub field is 3 bits which is used to indicate the group value of the volume sub field of the securities data; wherein,

when the group value of the *Volume field is 0, the length of the volume sub field is 5 bits, which is used to indicate the volume value from 0 to 31;

when the group value of the Volume field is 1, the length of the volume sub field is 10 bits, which is used to indicate the volume value from 32 to 1055;

when the group value of the Volume field is 2, the length of the volume sub field is 15 bits, which is used to indicate the volume value from 1056 to 33823;

when the group value of the Volume field is 3, the length of the volume sub field is 20 bits, which is used to indicate the volume value from 33824 to 1082399;

when the group value of the Volume field is 4, the length of the volume sub field is 25 bits, which is used to indicate the volume value from 1082400 to 341082636831;

when the group value of the Volume field is 5, the length of the volume sub field is 10 bits, which is used to indicate the value from 0 to 1023 and the right 2-digit is decimal place; and it needs to be multiplied by 10 to the exponent power again represented by the index sub field, for example, when the index sub field is 0 then multiply by 10̂3(K), when the index sub field is 1 then multiply by 10̂6(M), when the index sub field is 2 then multiply by 10̂9(B), when the index sub field is 3 then multiply by 10̂12(T);

when the group value of the Volume field is 6, the length of the volume sub field is 14 bits, which is used to indicate the value from 0 to 16383 and the right 2-digit is decimal place; and it needs to be multiplied by 10 to the exponent power again represented by the index sub field; and,

When the group value of the Volume field is 7, the length of the volume sub field is 17 bits, which is used to indicate the value from 0 to 131071 and the right 2-digit is decimal place; and it needs to be multiplied by 10 to the exponent power again represented by the index sub field.

Referring to Chart 7, which is to indicate one securities data transmission format after the encoding and compressing in the method for processing securities data according to another embodiment of the invention, the main purpose of the encoding format is to further reduce the transmission data amount when transmitting plenty of successive trading information of the same securities data code (the same stock, future, or option).

CHART 7
The securities data transmission format in the method
of processing securities data of the invention
Second Embodiment

| | | | Length | | |
|---|---|---|---|---|---|
| | | | [symbol] | Field | |
| Field Name | Sub Field 1 | Sub Field 2 | Bit) | Content | Description |
| Status | | | 1/3 | | 0: normal, 100: Price |
| | | | | | reaches Top, 101: Price |
| | | | | | reaches Bottom, 110: Up |
| | | | | | Trend (no field below) 111: |
| | | | | | Down Trend (no field |
| | | | | | below) |
| Time | | | 2/8/14 | Time | |
| | | | | group, | |
| | | | | please | |
| | | | | see chart | |
| | | | | 3 | |
| Trading | | | | | Trading price and volume |
| Information | | | | | |
| | Transmis- | | 9/12/14 | Transmis- | The transmission serial |
| | sion Serial | | | sion Serial | number SN of each |
| | Number SN | | | Number, | classification starts from 1. |
| | | | | please | |
| | | | | see chart | |
| | | | | 4 | |
| | Price | | var | Price | Trading price. SN1: relative |
| | Format | | | group, | to the reference price: last; |
| | | | | please | SNx, x > 1: relative to |
| | | | | see chart | SNx-1 |
| | | | | 5. | |
| | Volume | | var | Volume | Trading volume (single |
| | Format | | | group, | volume) |
| | | | | please | |
| | | | | see | |
| | | | | group 6 | |
| | Bid prices: | | var | Price | The first order Bid prices: |
| | Bid 1 | | | group | bid price 1, relative to the |
| | | | | | reference price: last |
| | Ask prices: | | var | Price | The first order Ask prices: |
| | Ask 1 | | | group | ask price 1, relative to the |
| | | | | | reference price: last |
| Number of | | | 3 | | Data Amount of Bid and |
| transmission | | | | | Ask prices and Volume |
| data orders | | | | | |
| (ba_data_count) | | | | | |
| First order data | | | | | Data Amount for first order |
| ba_data 1 | | | | | Bid and Ask prices and |
| | | | | | Volume |
| | Bid sizes: | | var | Volume | |
| | Bid volume | | | group | |
| | 1 | | | | |
| | Ask sizes: | | var | Volume | |
| | Ask | | | group | |
| | volume1 | | | | |
| Data after the | | | | | Repeat transmission data |
| second order | | | | | order and minus one time |
| ba_data x = | | | | | for it (ba_data_count − 1) |
| 2~5) | | | | | |
| | Number x | | | | Relative to the previous |
| | order bid | | | | order Bid prices: bid |
| | prices: Bid | | | | price (x-1) |
| | price x | | | | |
| | | same_as_above | 1 | | If the value of |
| | | | | | same_as_above is 1, then |
| | | | | | the value for Price Sub |
| | | | | | Field is the same as the |
| | | | | | precious order Bid prices |
| | | | | | information: bid price (x-1) |
| | | Price Sub | 0/var | Price | Relative to the precious |
| | | Field: price | | group | order Bid prices: bid price |
| | | | | | (x-1); if (same_as_above == |
| | | | | | 1), no such field. |
| | Number x | | var | Volume | |
| | order bid | | | group | |
| | sizes: Bid | | | | |
| | volume x | | | | |
| | Number x | | | | Relative to the precious |
| | order ask | | | | order Ask prices: ask price |
| | prices: Ask | | | | (x-1) |
| | price x | | | | |
| | | same_as_above | 1 | | If the value of |
| | | | | | same_as_above is 1, then |
| | | | | | the value for Price Sub |
| | | | | | Field is the same as the |
| | | | | | precious order Ask prices |
| | | | | | information: ask price (x-1) |
| | | Price Sub | 0/var | Price | Relative to the precious |
| | | Field: price | | group | order Ask prices: ask price |
| | | | | | (x-1); if (same_as_above == |
| | | | | | 1), no such field. |
| | Number x | | var | Volume | |
| | order ask | | | group | |
| | sizes: Bid | | | | |
| | volume x | | | | |

Wherein, data for the first order Bid and Ask prices (ba_data 1) have to be transmitted; each of the other prices is transmitted as the format relative to the previous order (x-1). If the Bid and Ask prices for the xth order (x) is the same as the previous order (x-1), fill value 1 into the same_as_above field and leave out the price sub field of the order; on the contrary if it is different, fill 0 into the same_as_above field, and fill the price difference relative to the price of the previous order (x-1) into the price sub field of the order. We can further reduce the necessary transmission data amount by such encoding sub-rule.

For example:

The trading price for certain stock at Jan. 12, 2007 is 31 Yuan (or Dollar), whose last order information with 5 prices is:

5 bids as below:

bid 1: 30.9 Yuan; Encode the first order data bid 1 relatively to the trading price as: 30.9−31=−0.1, therefore, proceed the encoding for −0.1 according to the format indicated in the price group of chart 5;

bid 2: 30.85 Yuan; Encode the second order bid 2 relatively to bid 1's 30.9 as: 30.85−30.9=−0.05, therefore, same_as_above=0, then encode −0.05 according to the price group;

bid 3: 30.8 Yuan; Encode the third order bid 3 relatively to bid 2's 30.85 as: 30.8−30.85=−0.05; the value is the same as the result of bid 2, therefore, same_as_above=1, then leave out the price sub field;

bid 4: 30.75 Yuan; Encode the forth order bid 4 relatively to bid 3's 30.8 as: 30.75−30.8=−0.05; the value is the same as the result of bid 3, therefore, same_as_above=1, then leave out the price sub field; and

bid 5: 30.7 Yuan; Encode the fifth order bid 5 relatively to bid 4's 30.75 as: 30.7−30.75=−0.05; the value is the same as the result of bid 3, therefore, same_as_above=1, then leave out the price sub field.

From the above embodiments we can know that the method of processing securities data of the invention can certainly encode and compress the data amount of the securities data, the compressing effect is particular remarkable when transmitting a plurality of securities data in one time. The data amount after the encoding of the method of processing securities data of the invention is less compared to the conventional technologies, moreover the usage amount of the transmission bandwidth can be reduced then we can raise the transmission efficiency for user to download the securities data through wireless communication media.

The preferred embodiments of the invention have been disclosed above, which however should not be construed as a limitation on the actual application of the invention. Hence all modifications and alterations made by those familiar with the skill without departing from the spirits of the invention and appended claims shall remain within the protected scope of the invention.

What is claimed is:

1. A method for processing securities data, comprising:
building an encoding rule, according to each field content contained in each securities data, the encoding rule decides a corresponding classification and a corresponding group, and each classification and each group has a corresponding encoding sub-rule;
acquiring a plurality of the securities data; and,
proceeding an encoding process to each securities data respectively according to the encoding sub-rule corresponding to the classification and the group.

2. The method of claim 1, wherein the securities data is one of the following: stock trading data, futures trading data and option trading data.

3. The method of claim 1, wherein the securities data comprises at least the following fields: code, transmission serial number, price, volume, and time.

4. The method of claim 3, wherein the way to determine the classification is to proceed the classification according to the code of the securities data, such that the securities data with the same code will be classified into the same classification and rearrange the transmission serial number.

5. The method of claim 4, wherein the Price field of the securities data further comprises a group sub field, a price sub field, and a decimal sub field; moreover, the encoding sub-rule further comprises:
in any classification, the price of the securities data is represented by relative price; the relative price is a price difference for the securities data price and a certain reference price to minus mutually; the first order securities data takes a Close Price of a previous trading day as a reference price, and then, each of the following securities data takes its previous order securities data as reference price; wherein the value of the group sub field is used to represent the encoding sub-rule for the price sub field of the securities data.

6. The method of claim 5, wherein the length of the group sub field of the Price field is 3 bits, which is used to represent a group value from 0 to 7, and the length of the decimal sub field of the Price field is less than 2 bits, which is used to represent how many decimal places are contained in the value of the price sub field; wherein:
when the group value of the Price field is 0, the length of the price sub field is 5 bits, which is used to indicate a absolute price value from 0 to 31;
when the group value of the Price field is 1, the length of the price sub field is 10 bits, which is used to indicate the absolute price value from 32 to 1055;
when the group value of the Price field is 2, the length of the price sub field is 15 bits, which is used to indicate the absolute price value from 1056 to 33823;
when the group value of the Price field is 3, the length of the price sub field is 20 bits, which is used to indicate the absolute price value from 33824 to 1082399;
when the group value of the Price field is 4, the length of the price sub field is 0 bit, which is used to indicate the relative price value is 0;
when the group value of the Price field is 5, the length of the price sub field is 2 bits, which is used to indicate the relative price value as one of the following: 1, −1, 5, −5;
when the group value of the Price field is 6, the length of the price sub field is 3 bits, which is used to indicate the relative price value as one of the following: 2˜4, 6, −2˜−4, and −6; and,
when the group value of the Price field is 7, the length of the price sub field is 5 bits, which is used to indicate the relative price value as one of the following: 7˜22 and −7˜−22.

7. The method of claim 4, wherein the transmission serial number field of the securities data further comprises a group sub field and a serial number sub field; the length of the group sub field is 2 bits, which is used to represent a group value of the serial number sub field of the securities data; wherein:
when the group value of the serial number field is 0, the length of the serial number sub field is 8 bits, which is used to indicate the transmission serial number from 1 to 256;
when the group value of the serial number field is 2, the length of the serial number sub field is 10 bits, which is used to indicate the transmission serial number from 257 to 1280; and,
when the group value of the serial number field is 3, the length of the serial number sub field is 12 bits, which is used to indicate the transmission serial number from 1281 to 5376.

8. The method of claim 4, wherein the time field of the securities data further comprises a group sub field and a time sub field; the length of the group sub field is 2 bits, which is used to represent a group value of the time sub field of the securities data; wherein:
when the group value of the time field is 0, the length of the time sub field is 1 bit, which is used to indicate a time difference value for the securities data relative to the previous order securities data as 0 minute or 1 minute or one of them;
when the group value of the time field is 2, the length of the time sub field is 6 bits, which is used to indicate a time difference value for the securities data relative to Open Market Time; the unit of the value in the time sub field is minute and it is between 2 and 65; and,
when the group value of the time field is 3, the length of the time sub field is 12 bits, which is used to indicate a absolute time value for the securities data; the unit of the value in the time sub field is minute and it is between 0 and 1439.

9. The method of claim 4, wherein the Volume field of the securities data further comprises a group sub field, a volume sub field, and an index value; the length of the index value field is not longer than 2 bits, which is used to represent that the value of the volume sub field should be multiplied by 10 to the exponent power again; the length of the group sub field is 3 bits, which is used to indicate a group value of the volume sub field of the securities data; wherein:
when the group value of the *Volume field is 0, the length of the volume sub field is 5 bits, which is used to indicate the volume value from 0 to 31;
when the group value of the Volume field is 1, the length of the volume sub field is 10 bits, which is used to indicate the volume value from 32 to 1055;
when the group value of the Volume field is 2, the length of the volume sub field is 15 bits, which is used to indicate the volume value from 1056 to 33823;
when the group value of the Volume field is 3, the length of the volume sub field is 20 bits, which is used to indicate the volume value from 33824 to 1082399;
when the group value of the Volume field is 4, the length of the volume sub field is 25 bits, which is used to indicate the volume value from 1082400 to 341082636831;
when the group value of the Volume field is 5, the length of the volume sub field is 10 bits, which is used to indicate a value from 0 to 1023 and its right 2-digit are decimal places; and it needs to be multiplied by 10 to the exponent power again represented by the index sub field;
when the group value of the Volume field is 6, the length of the volume sub field is 14 bits, which is used to indicate the value from 0 to 16383 and its right 2-digit are decimal places; and it needs to be multiplied by 10 to the exponent power again represented by the index sub field; and,
when the group value of the Volume field is 7, the length of the volume sub field is 17 bits, which is used to indicate the value from 0 to 131071 and its right 2-digit are decimal places; and it needs to be multiplied by 10 to the exponent power again represented by the index sub field.

10. A method for processing securities data, comprising:
accepting a securities data download request;
acquiring a plurality of securities data according to the request;
proceeding an encoding process to each securities data respectively according to an encoding rule; according to each field content contained in each securities data, the encoding rule decides a corresponding classification and a corresponding group, and each classification and each group has a corresponding encoding sub-rule.

11. The method of claim 10, wherein the securities data is one of the following: stock trading data, futures trading data and option trading data.

12. The method of claim 10, wherein the securities data comprises at least the following fields: code, transmission serial number, price, volume, and time.

13. The method of claim 12, wherein the way to determine the classification is to proceed the classification according to the code of the securities data, such that the securities data with the same code will be classified into the same classification and rearrange the transmission serial number.

14. The method of claim 13, wherein the Price field of the securities data further comprises a group sub field, a price sub field, and a decimal sub field; moreover, the encoding sub-rule further comprises:
in any classification, the price of the securities data is represented as relative price; the relative price is a price difference for the securities data price and a certain reference price to minus mutually; the first order securities data takes a Close Price of the previous trading day as the reference price, and then, each of the following securities data takes its previous order securities data as reference price; wherein the value of the group sub field is used to represent the encoding sub-rule for the price sub field of the securities data.

15. The method of claim 14, wherein the length of the group sub field of the Price field is 3 bits, which is used to represent a group value from 0 to 7, and the length of the decimal sub field of the Price field is less than 2 bits, which is used to represent how many decimal places are contained in the value of the price sub field; wherein:
when the group value of the Price field is 0, the length of the price sub field is 5 bits, which is used to indicate a absolute price value from 0 to 31;
when the group value of the Price field is 1, the length of the price sub field is 10 bits, which is used to indicate the absolute price value from 32 to 1055;
when the group value of the Price field is 2, the length of the price sub field is 15 bits, which is used to indicate the absolute price value from 1056 to 33823;
when the group value of the Price field is 3, the length of the price sub field is 20 bits, which is used to indicate the absolute price value from 33824 to 1082399;
when the group value of the Price field is 4, the length of the price sub field is 0 bit, which is used to indicate the relative price value is 0;
when the group value of the Price field is 5, the length of the price sub field is 2 bits, which is used to indicate the relative price value as one of the following: 1, −1, 5, −5;
when the group value of the Price field is 6, the length of the price sub field is 3 bits, which is used to indicate the relative price value as one of the following: 2˜4, 6, −2˜−4, and −6; and,
when the group value of the Price field is 7, the length of the price sub field is 5 bits, which is used to indicate the relative price value as one of the following: 7˜22 and −7˜−22.

16. The method of claim 13, wherein the transmission serial number field of the securities data further comprises a group sub field and a serial number sub field; the length of the group sub field is 2 bits, which is used to represent a group value of the serial number sub field of the securities data; wherein:
when the group value of the serial number field is 0, the length of the serial number sub field is 8 bits, which is used to indicate the transmission serial number from 1 to 256;
when the group value of the serial number field is 2, the length of the serial number sub field is 10 bits, which is used to indicate the transmission serial number from 257 to 1280; and,
when the group value of the serial number field is 3, the length of the serial number sub field is 12 bits, which is used to indicate the transmission serial number from 1281 to 5376.

17. The method of claim 13, wherein the time field of the securities data further comprises a group sub field and a time sub field; the length of the group sub field is 2 bits, which is used to represent a group value of the time sub field of the securities data; wherein:
when the group value of the time field is 0, the length of the time sub field is 1 bit, which is used to indicate a time difference value for the securities data relative to the previous order securities data as 0 minute or 1 minute or one of them;
when the group value of the time field is 2, the length of the time sub field is 9 bits, which is used to indicate a time difference value for the securities data relative to Open Market Time; the unit of the value in the time sub field is minute and it is between 0 and 511; and,
when the group value of the time field is 3, the length of the time sub field is 12 bits, which is used to indicate a absolute time value for the securities data; the unit of the value in the time sub field is minute and it is between 0 and 1439.

18. The method of claim 13, wherein the Volume field of the securities data further comprises a group sub field, a volume sub field, and an index value; the length of the index value field is not longer than 2 bits, which is used to represent that the value of the volume sub field should be multiplied by 10 to the exponent power again; the length of the group sub field is 3 bits, which is used to indicate a group value of the volume sub field of the securities data; wherein:
when the group value of the Volume field is 0, the length of the volume sub field is 5 bits, which is used to indicate the volume value from 0 to 31;
when the group value of the Volume field is 1, the length of the volume sub field is 10 bits, which is used to indicate the volume value from 32 to 1055;
when the group value of the Volume field is 2, the length of the volume sub field is 15 bits, which is used to indicate the volume value from 1056 to 33823;
when the group value of the Volume field is 3, the length of the volume sub field is 20 bits, which is used to indicate the volume value from 33824 to 1082399;
when the group value of the Volume field is 4, the length of the volume sub field is 25 bits, which is used to indicate the volume value from 1082400 to 341082636831;
when the group value of the Volume field is 5, the length of the volume sub field is 10 bits, which is used to indicate a value from 0 to 1023 and its right 2-digit are decimal places; and it needs to be multiplied by 10 to the exponent power again represented by the index sub field;
when the group value of the Volume field is 6, the length of the volume sub field is 14 bits, which is used to indicate the value from 0 to 16383 and its right 2-digit are decimal places; and it needs to be multiplied by 10 to the exponent power again represented by the index sub field; and,
when the group value of the Volume field is 7, the length of the volume sub field is 17 bits, which is used to indicate the value from 0 to 131071 and its right 2-digit are decimal places; and it needs to be multiplied by 10 to the exponent power again represented by the index sub field.

19. A method for processing securities data, comprising:
analyzing a plurality of fields of a plurality of securities data in order to respectively conclude an appearance frequency statistic of the field values contained in each securities data;
defining a grouping and encoding process for the field according to the appearance frequency, and unifying the grouping and encoding processes for all fields into an encoding rule; and,
encoding the other securities data according to the encoding rule.

20. The method of claim 19, wherein each of the securities data comprises at least the following fields: code, transmission serial number, price, volume, and time; and the encoding rule comprises:
proceeding the classification according to the code of the securities data, such that the securities data with the same code will be classified into the same classification and rearranging the transmission serial number; and deciding a length of the transmission serial number field according to a magnitude of the max transmission serial number value of the same classification;
in any classification, the price of the securities data is represented as relative price; the relative price is a price difference for the securities data price and a certain reference price to minus mutually; the first order securities data takes a Close Price of the previous trading day as the reference price and each of the following securities data takes its previous order securities data as reference price; and decide a length of the Price field and its encoding sub-rule according to a magnitude of the value of the Price field;
in any classification, according to a magnitude of a time difference for the securities data relative to a previous order securities data to decide the value of the time field as one of the following: time difference relative to the previous order securities data, or time difference relative to Open Market Time, or absolute time; and decide a length of the time field according to the value after the decision of the time field; and,
in any classification, decide a length of the Volume field and its encoding sub-rule according to a magnitude of the value of the Volume field of each securities data.
